(19) United States
(12) Patent Application Publication
(10) Pub. No.: US 2004/0129125 A1
(43) Pub. Date: Jul. 8, 2004

(54) Cutting tool with depth of cut markings

(76) Inventor: Ross M. Colquhoun, Penticton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/737,775

(22) Filed: Dec. 18, 2003

Related U.S. Application Data
(60) Provisional application No. 60/437,658, filed on Jan. 2, 2003.
(60) Provisional application No. 60/443,073, filed on Jan. 28, 2003.

(51) Int. Cl. B26D 7/27

(52) U.S. Cl. 83/835; 83/522.15; 408/226; 345/87

(57) ABSTRACT

A cutting tool such as a saw blade or drill bit, having a cutting portion having a body and one or more cutting tips on the body. A set of markings on the body indicate the distance between the cutting tip and each marking, to indicate to a user the depth of cut to which the tool has penetrated into a workpiece. The markings can be painted, etched, printed, peened on the body or applied in other desired manner.

### PRIOR APPLICATION

This application claims the benefit of U.S. Provisional Application Serial No. 60/437,658, filed Jan. 2, 2003 entitled CONCENTRIC CIRCULAR MARKINGS ON SAW BLADE ALLOW QUICK CALIBRATION OF DEPTH OF CUT and U.S. Provisional Application Serial No. 60/443,073, filed Jan. 28, 2003 entitled MARKINGS ON DRILL AND ROUTER BITS ALLOW QUICK CALIBRATION OF DEPTH OF CUT AND OTHER EMBODIMENTS OF MARKINGS ON SAW BLADE ALLOWING QUICK CALIBRATION OF DEPTH OF CUT.

### FIELD OF THE INVENTION

This invention relates to cutting tools, such as circular saw blades, drill bits, router bits, dado blades and hole saws. The invention provides a means to allow simple and accurate control of the depth of cut of the cutting tool.

### BACKGROUND OF THE INVENTION

While cutting tools are often used to cut or drill through a workpiece, they are also often used to cut or drill to a desired depth which is only partway through the workpiece. In these situations, it is necessary to control the depth of the cut, hole or other opening formed by the tool in the workpiece.

Unfortunately, there has not until now been any simple way of controlling the depth of the cut or opening which is made in the workpiece. Achievement of the correct depth has depended on the skill and experience of the person performing the work and this has led to variable results. While mechanical attachments have long been available to try to control the depth of cut, they have been complex and unsatisfactory.

### BRIEF SUMMARY OF THE INVENTION

Accordingly, the invention provides a means to control more easily and accurately the depth of the cut or other opening formed in a workpiece by a cutting tool. In one aspect, the invention provides a cutting tool for making a cut or other opening in a workpiece, said cutting tool comprising a cutting portion having a body and a cutting tip on said body, and a set of markings on said body to indicate the distance between said tip and each said marking, for indicating to a user the depth to which said tool has penetrated into said workpiece.

Further objects and advantages of the invention will appear from the following disclosure, taken together with the accompanying drawings.

### BRIEF DESCRIPTION OF DRAWINGS

In the drawings:

FIG. 1 is a side view of a circular saw blade containing markings according to the invention;

FIG. 2 is a side view of a drill bit containing markings according to the invention;

FIG. 3 is a side view of another form of drill bit containing markings according to the invention;

FIG. 4 is a side view of a router bit containing markings according to the invention; and

FIG. 5 is a side view of a dado blade containing markings according to the invention.

### DETAILED DESCRIPTION OF PREFERRED EMBODIMENTS

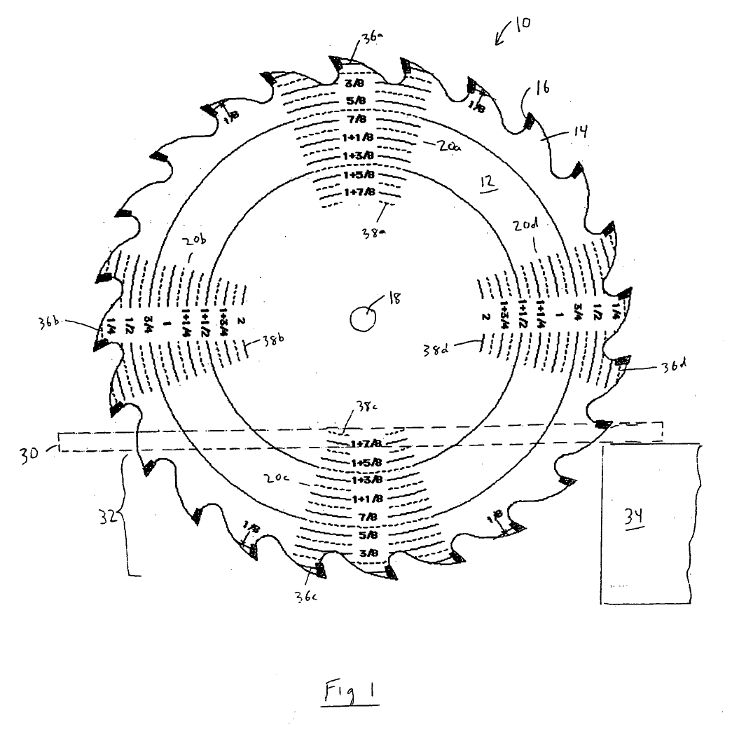

Reference is first made to FIG. 1, which shows a conventional circular saw blade 10 having a body 12 and cutting teeth 14. The teeth 14 have tips 16. The body 12 contains a central hole 18 to mount the blade on a spindle in conventional manner. (For hand held saws, there is usually a diamond shaped knock-out, not shown, around the hole 18 for a worm-drive saw blade mounting.)

In accordance with the invention, the blade 12 contains four sets of concentric arcuate markings 20a, 20b, 20c and 20d which indicate the radial distance from the tip 16 of each tooth 14 to the location of the marking in question.

The markings 20a-20d can be calibrated in inches, as shown in the drawing, or they can be calibrated in the metric system (centimeters and millimeters), as preferred. For easier viewing, adjacent markings can differ from each other, e.g. they can alternate between solid and dashed lines, or they can be of different colors.

As shown in FIG. 1, the markings 20a-20d primarily consist of concentric arcs, which increase in arcuate length from the center of the saw blade toward its periphery (since more room is available at the outer periphery), to facilitate viewing. In addition, at selected depths (shown in FIG. 1 as

$$\frac{3}{4}$$

inch and

$$1 \frac{1}{2}$$

inches), the markings can extend in a circle entirely around the saw blade, as indicated at 22, 24, again for easier viewing. The user can interpolate between the markings (or the markings can be as fine as necessary).

As is well-known, circular saw blades are often used in a manner such that they protrude through a sole plate, shown in dotted lines at 30 in FIG. 1. The portion 32 of the blade which protrudes past the sole plate (on the side of the sole plate remote from mounting hole 18) is the portion of the blade which cuts the workpiece (diagrammatically indicated at 34). In some saws, such as radial arm saws, the portion 32 projects downwardly from the sole plate 30, while in other saws (such as table saws), the portion 32 projects upwardly from the sole plate 30 (the sole plate 30 in that case consists of the table surface of the table saw). Of course, some saws, such as many radial arm saws, and chop saws, do not have a sole plate.

To facilitate reading of the markings in both these situations, each set of markings 20a-20d has a top 36a-36d and a bottom 38a-38d. The terms “top” and “bottom” refer to the orientation in which the text of the markings can be read.

As shown in FIG. 1, the four sets of markings 20a-20d are arranged along two diameters of the blade 10, at right angles to each other. On each diameter, one set of markings has its top adjacent the tips 16 of teeth 14 (here, markings 20a and 20d), while the other set of markings (here sets 20b and 20c) have their bottoms adjacent the tips 16 of teeth 14. In this manner, at least one set of markings will be right side up whether the blade 10 is protruding upwardly or downwardly through the sole plate 30.

While the markings 20a-20d have been shown as divided into four substantially discrete sets, this can be varied as desired. For example, the entire side surface of the saw blade 10 can be marked with circular lines to indicate the depth of cut. In addition, the depth of cut markings described are preferably applied to both sides of the saw blade.

As shown in FIG. 2, the markings of the invention can also be applied to a drill bit 50 having a tip 52, a body 54 and a shank 56. In FIG. 2, markings 58 are shown as applied to the body 54, indicating the axial distance or depth of cut from the tip 52.

FIG. 3 shows a spade-type drill bit 60 having a body 62. Body 62 includes a lower cutting edge 64, a guide projection 66, and a shank 68. Markings 70 are applied to the drill bit 60 and shank 68 to indicate the axial distance or depth of cut from the marking in question to the cutting edge 64. (The guide projection 66 is usually present simply to guide the drill bit 60 in its hole and is not normally considered to qualify as forming part of the depth of cut.)

FIG. 4 shows a router bit 74 having a body 76 with a lower cutting edge 78 and a shank 80. Markings 82 are applied to the body 76 and shank 80 to show the axial distance or depth of cut from each marking to the bottom cutting edge 78.

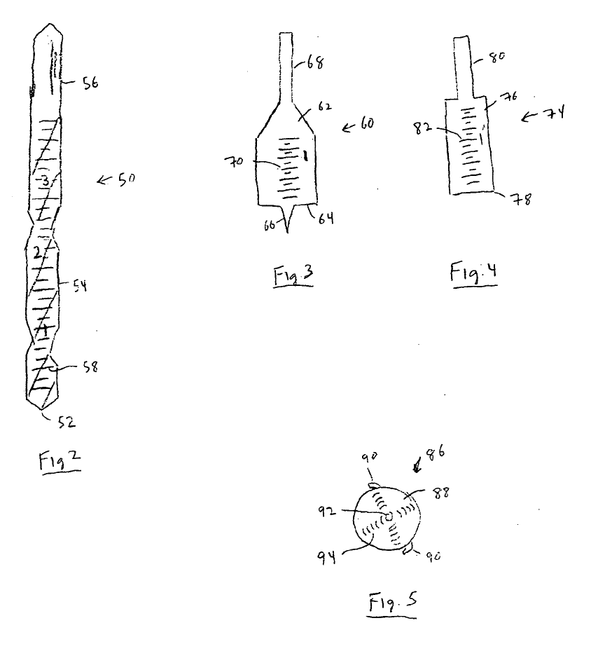

FIG. 5 shows a dado blade 86 having a body 88 which supports cutting teeth 90 (much like a saw blade), and having a mounting hole 92. As in the case of the saw blade in FIG. 1, markings 94 are applied to the side of the dado blade to indicate the radial distance or depth of cut from the marking in question to the tips of the teeth 90, for accurate control of the depth of the groove formed by the dado blade 86.

The metal of the cutting tools shown can be marked in any desired manner. For example, the metal can be etched, either mechanically, or chemically, or using an electrochemical process. Alternatively, laser marking can be used, with or without chemicals which change the color of the marks formed by the laser (if the color is changed, this can improve contrast and legibility).

As another alternative, a painted tool can be used with laser marking which burns the paint off, leaving remaining paint and burnished metal color to form contrasting markings.

Alternative methods of marking the cutting tool include the use of decals (which however may come off in use), water jets, silkscreen printing processes, stencil marking, letterpress printing, pad printing (using epoxy ink), jet printers using ink or other appropriate liquids, dot peening to form a series of dots in the metal, or (in the case of saw blades) actual perforations in the metal.

The markings described can be applied to various kinds of cutting tools, e.g. to hole saws. The tools can be used for various purposes, such as woodworking, metal working, plastics, and other materials, and even for medical surgery.

It will be understood that in use, to achieve an accurate and regular depth of cut with saw blades marked according to the invention, the operator may simply sight across the base of the sole plate (or table) to the arcuate line on the blade which line indicates the desired depth of cut, and then adjust the height of the blade relative to the sole plate (or table) to this line, thus to make the correct cut. If there is no table or sole plate, then the operator will manually control the depth of cut so that the line indicating the desired depth of cut is located at the top of the cut, flush with the surface of the workpiece being cut, while the cut is being made.

In the case of drills, bits and hole saws, the operator feeds the tool into the workpiece until the line marked with the desired depth of cut is again level with the upper surface of the workpiece. In larger diameter bits and hole saws, the depth of cut lines have the added advantage of indicating the perpendicularity of the bit or hole saw to the workpiece.

It should be noted that when for example a saw blade marked according to the invention is sharpened, only a very small amount of material is removed from the blade (typically 0.007 inches). Since the thickness of the markings is typically about 0.025 inches, therefore the markings will retain their accuracy over a number of sharpenings.

While preferred embodiments of the invention have been described, it will be realized that various changes can be made within the scope of the invention.

I claim:

1. A cutting tool for making a cut or other opening in a workpiece, said cutting tool comprising a cutting portion having a body and a cutting tip on said body, and a set of markings on said body to indicate the distance between said tip and each said marking, for indicating to a user the depth to which said tool has penetrated into said workpiece.

2. A cutting tool according to claim 1 wherein said tool is a saw blade.

3. A cutting tool according to claim 2 wherein said saw blade is a circular saw blade.

4. A cutting tool according to claim 3 wherein said markings comprise at least one set of concentric arcuate markings.

5. A cutting tool according to claim 4 wherein there are at least two sets of said markings, each set having a top and a bottom, one set being oriented with its top facing toward said cutting tip and the other set being oriented with its bottom facing toward said cutting tip, so that said markings can be read with said blade extending upwardly or downwardly through a sole plate.

6. A cutting tool according to claim 1 wherein said markings are printed on said tool.

7. A cutting tool according to claim 1 wherein said markings are etched on said tool.

8. A cutting tool according to claim 1 wherein said markings are engraved on said tool.

9. A cutting tool according to claim 1 wherein said tool is a drill bit.

10. A cutting tool according to claim 1 wherein said tool is a router bit.

11. A cutting tool according to claim 1 wherein said tool is a dado blade.
